(19) United States
(12) Patent Application Publication
(10) Pub. No.: US 2026/0106179 A1
(43) Pub. Date: Apr. 16, 2026

(54) FUEL-ELECTRODE SUPPORTED SOLID OXIDE CELL AND MANUFACTURING METHOD THEREOF

(71) Applicant: Pusan National University Industry-University Cooperation Foundation, Busan (KR)

(72) Inventors: Beom-Kyeong PARK, Busan (KR); Hae-In JEONG, Busan (KR); Su-Wan KIM, Busan (KR)

(21) Appl. No.: 19/348,617

(22) Filed: Oct. 2, 2025

(30) Foreign Application Priority Data
Oct. 10, 2024 (KR) 10-2024-0138034

(51) Int. Cl. H01M 4/88; H01M 4/90; H01M 8/12; H01M 8/1213; H01M 8/1253

(52) U.S. Cl. CPC H01M 4/8885; H01M 4/9033; H01M 8/1213; H01M 8/1253; H01M 2008/1293

(57) ABSTRACT

A method for manufacturing a fuel electrode supported solid oxide cell includes preparing at least one of a fuel electrode support, a fuel electrode functional layer, an electrolyte layer, and a reaction barrier layer, respectively; stacking the fuel electrode support, the fuel electrode functional layer, the electrolyte layer, and the reaction barrier layer to form a laminate; and co-firing the laminate at 1240° C. or higher and lower than 1280° C. for 2 to 6 hours.

### CROSS-REFERENCE TO RELATED APPLICATION

The present application claims priority under 35 U.S.C. § 119(a) to Korean Patent Application No. 10-2024-0138034 filed in the Korean Intellectual Property Office on Oct. 10, 20324, which is incorporated herein by reference in its entirety.

### TECHNICAL FIELD

The present disclosure relates to a fuel electrode supported solid oxide cell and a method of manufacturing the same, and more particularly, to a fuel electrode supported solid oxide cell to which a double-layer electrolyte is applied and a method of manufacturing the same.

### BACKGROUND ART

A solid oxide cell is a cell that converts fuel into electricity or converts electricity into fuel through an electrochemical device, and it largely includes a solid oxide fuel cell (SOFC) and a solid oxide electrolytic cell (SOEC).

These solid oxide fuel cells and steam electrolysis are attracting attention as important technologies for realizing carbon neutrality due to their high energy conversion efficiency and possibility of using various fuels. In particular, a double-layered electrolyte made of zirconia (YSZ) and ceria is an essential key component for developing high-performance fuel electrode-supported cells.

In a conventional manufacturing process of a fuel electrode supported cell, an yttria-stabilized zirconia (YSZ) electrolyte layer is formed on a nickel oxide-yttria stabilized zirconia (NiO-YSZ) fuel electrode substrate, and after pre-sintering, a ceria-based barrier layer is formed on the YSZ layer. Thereafter, co-sintering is performed at a high temperature of 1350-1450° C., to manufacture a double-layer electrolyte, although performance decline occurs due to YSZ/ceria interaction. Alternatively, a ceria-based barrier layer is further formed on the already sintered YSZ layer through a vacuum deposition-based post-treatment process.

However, the above-described manufacturing process has a disadvantage in that it undergoes a plurality of sintering processes, making the process complicated, having a high process cost, and requiring a lot of time to manufacture a single cell.

Accordingly, there is a need to develop a technology for a fuel electrode supported solid oxide cell in which a fuel electrode, an electrolyte layer, and a reaction barrier layer are simultaneously sintered to simplify a manufacturing process while having excellent performance.

### DESCRIPTION OF THE DISCLOSURE

### Technical Problem to be Solved

The object of the present disclosure is to provide a fuel electrode supported solid oxide cell having a dual-layer electrolyte with excellent performance and durability, and manufactured by a low-temperature single process, and a method for manufacturing the same.

The problems to be solved by the present disclosure are not limited to the problems mentioned above, and other problems not mentioned may be clearly understood by those skilled in the art from the following description.

### Means for Solving the Problem

To achieve the above object, the present disclosure provides a method of manufacturing a fuel electrode supported solid oxide cell comprising: preparing at least one of a fuel electrode support, a fuel electrode functional layer, an electrolyte layer, and a reaction barrier layer; stacking the fuel electrode support, the fuel electrode functional layer, the electrolyte layer, and the reaction barrier layer to form a laminate; and sintering the laminate at 1240° C. or higher and lower than 1280° C. for 2 to 6 hours.

The laminate may be formed by laminating the fuel electrode support, the fuel electrode functional layer, the electrolyte layer, and the reaction barrier layer at 60 to 80° C. and a pressure of 4000 to 6000 psi.

The laminate may have the fuel electrode functional layer, the electrolyte layer, and the reaction barrier layer sequentially stacked on one surface of at least one of the fuel electrode supports.

The sintering step may be sintering the stacked body at 1250 to 1260° C. for 4 hours.

The fuel electrode support and the fuel electrode functional layer may each comprise a sheet obtained by tape casting a slurry including at least one selected from the group consisting of nickel oxide (NiO), yttria-stabilized zirconia (YSZ), a pore former, and combinations thereof.

The electrolyte layer may comprise a sheet obtained by tape casting a slurry containing yttria-stabilized zirconia (YSZ).

The reaction barrier layer may comprise a sheet obtained by tape-casting a slurry containing samarium-doped ceria (SDC).

The electrolyte layer or the reaction barrier layer may further comprise a sintering aid in the slurry.

The sintering aid may comprise one or more selected from the group consisting of copper, copper oxide, cobalt, cobalt oxide, manganese, manganese oxide, zinc, zinc oxide, iron, iron oxide, lithium, and lithium oxide.

The electrolyte layer may comprise a sintering aid in an amount of 1 to 3 wt % based on 100 wt % of yttria-stabilized zirconia.

The reaction barrier layer may include a sintering aid of 0 to 3 wt % based on a total of 100 wt % of samaria-doped ceria.

The reaction barrier layer may include samaria-doped ceria represented by the following Chemical Formula 1:

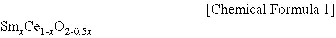

Herein, x is between 0.1 and 0.3.

The pore-forming agent may comprise at least one selected from the group consisting of carbon black, graphite, starch, and combinations thereof.

The fuel electrode support may be manufactured by preparing a slurry including 40 to 60 wt % of nickel oxide, 5 to 25 wt % of a pore former, and a remainder of yttria-stabilized zirconia.

The fuel electrode functional layer may be manufactured by preparing a slurry including 40 to 60 wt % of nickel oxide, 0 to 20 wt % of a pore former, and the remainder of yttria-stabilized zirconia.

The method may further include forming an oxygen electrode (cathode) layer on one surface of the reaction barrier layer.

Additionally, the present disclosure provides a fuel cell support type solid oxide fuel cell manufactured by the above-described manufacturing method.

The fuel electrode-supported solid oxide cell may be applied to a fuel cell or an electrolysis system.

### Effects of the Disclosure

The present disclosure can manufacture a fuel electrode-supported solid oxide fuel cell with a double-layer electrolyte having excellent performance and durability by using a powder having a low specific surface area of 9 m²/g or less in a low-temperature single process.

In addition, the present disclosure can improve the efficiency and durability of the unit cell by suppressing the reaction between the oxygen electrode and the electrolyte due to the formation of a fairly dense reaction barrier layer and minimizing the formation of an insulating layer between the electrolyte and the reaction barrier layer.

In addition, the present disclosure can reduce the manufacturing cost of a solid oxide fuel cell through a single sintering process, and can manufacture a fuel electrode-supported solid oxide fuel cell that can secure mechanical strength by using tape-casting.

The effects of the present disclosure are not limited to the above-mentioned effects, and it should be understood that the present disclosure includes all effects inferable from the detailed description of the present disclosure or the configuration of the disclosure described in the claims.

### BRIEF DESCRIPTION OF THE DRAWINGS

FIG. 1 is a series of views showing a manufacturing process result of a NiO-YSZ-supported half-cell through tape casting, uniaxial pressing, and a single-step 1250° C. co-firing according to an example of the present disclosure, which includes (a) a NiO-YSZ supporting layer, a NiO-YSZ fuel electrode, a YSZ electrolyte, and an SDC barrier layer, (b) a stacked state, (c) a sintered half-cell, (d) half-cells manufactured in various sizes, and (e) a large-area cell to which an oxygen electrode of 9 cm² is applied.

FIG. 2 shows the microstructural analysis results of the solid oxide unit cell fabricated through the present disclosure, which include (a) a fractured surface SEM image, (b) an FIB-SEM image, (c) an SEM-EDS analysis result, and (d) a TEM-EDS analysis result.

FIG. 3 shows fuel cell and steam electrolysis performance results of the solid oxide unit cell manufactured by the present disclosure.

FIG. 4 shows the results of a long-term stability test in a fuel cell mode of a solid oxide unit cell manufactured according to the present disclosure, which includes (a) cell voltage change over time, (b) cell impedance over time, and (c) post-microstructure analysis results.

FIG. 5 is a photograph (a) of a solid oxide unit cell manufactured according to Example 2 taken with a camera, and shows (b) impedance results and (c) voltage-current-power curve results of the solid oxide unit cell.

FIG. 6 shows a photograph taken by a camera of a solid oxide unit cell manufactured according to Comparative Example 1.

FIG. 7 shows (a) an impedance result and (b) a voltage-current-power curve result of the solid oxide unit cell manufactured according to Comparative Example 2.

FIG. 8 is a photograph of the solid oxide unit cell manufactured according to Comparative Example 2, taken with a camera.

FIG. 9 shows (a) an impedance result and (b) a voltage-current-power curve result of the solid oxide unit cell manufactured according to Comparative Example 4.

FIG. 10 is a fractured cross-sectional SEM image for confirming the microstructure of the solid oxide unit cell manufactured according to Example 3.

FIG. 11 is a fractured cross-sectional SEM image for confirming the microstructure of the solid oxide unit cell manufactured according to Comparative Example 5.

FIG. 12 is a fractured cross-sectional SEM image for confirming the microstructure of the solid oxide unit cell manufactured according to Comparative Example 6.

FIG. 13 is a fractured cross-sectional SEM image for confirming the microstructure of the solid oxide unit cell manufactured according to Comparative Example 7.

FIG. 14 shows (a) fractured cross-sectional SEM image for confirming the microstructure of the solid oxide unit cell manufactured according to Comparative Example 8, and (b) is a graph showing the cell performance results.

FIG. 15 is a fractured SEM image for confirming the microstructure of the solid oxide unit cell manufactured according to Comparative Example 9.

FIG. 16 shows the results of ohmic resistance at various temperatures for the solid oxide unit cell manufactured according to Comparative Example 10.

FIG. 17 shows (a) an impedance result and (b) a voltage-current-power curve result of the solid oxide unit cell manufactured according to Comparative Example 11.

FIG. 18 shows (a) an impedance result and (b) a voltage-current-power curve result of the solid oxide unit cell manufactured according to Comparative Example 13.

FIG. 19 shows (a) is an impedance result of the solid oxide cell manufactured according to Example 4 and Comparative Example 14, and (b) is a fractured SEM image for confirming the microstructure of a unit cell of the solid oxide cell manufactured according to Comparative Example 14.

### DETAILED DESCRIPTION OF THE DISCLOSURE

In the following description, only the parts necessary for understanding the examples of the present disclosure will be described, and the descriptions of the other parts may be omitted within a range that does not obscure the gist of the present disclosure.

The terms and words used in the specification and claims described below should not be interpreted in a conventional or dictionary sense, but should be interpreted with a meaning and concept consistent with the technical idea of the present disclosure, based on the principle that the inventor can define the concept of the term appropriately for the best description of his/her disclosure. Therefore, the examples described in the specification and the configurations shown in the drawings are only preferred examples of the present disclosure, and do not represent all the technical ideas of the present disclosure. Therefore, it should be understood that there may be various equivalents and modifications that can replace them at the time of the present application.

In a general manufacturing process of a supported fuel cell, an yttria-stabilized zirconia (YSZ) electrolyte layer is coated on a nickel oxide-yttria stabilized zirconia (NiO-YSZ) fuel electrode substrate, and after pre-sintering, a ceria-based barrier layer is formed on the YSZ layer. Thereafter, co-sintering is performed at a high temperature of 1350-1450° C., to form a double-layer electrolyte. Alternatively, a ceria-based barrier layer is further formed on the already sintered YSZ layer through a vacuum deposition-based post-treatment process.

However, the above-described manufacturing process has a disadvantage in that it undergoes a plurality of sintering processes, making the process complicated, having high process costs, and requiring a lot of time for manufacturing a single cell. In addition, since ceria has low sinterability, it is necessary to use a powder with a relatively high specific surface area, which leads to low economic efficiency.

In particular, at high temperatures such as the sintering temperature mentioned above, ceria-based materials generally react with the YSZ electrolyte to form a reaction product having a high electrical resistance, and the pore structure of the sintered fuel electrode is deteriorated, resulting in undesirable electrochemical performance of the unit cell.

Accordingly, the inventor of the present disclosure has simplified the process by using a double-layer structure in which ‘Yttria (Y₂O₃) stabilized zirconia (YSZ)’ and ‘Sm (Samarium) doped ceria (SDC)’ are applied as electrolyte materials, thereby enabling simultaneous sintering of the support, fuel electrode, and double-layer electrolyte layer. In particular, the present disclosure was completed by maximizing the electrical properties of the double-layer electrolyte through a low-temperature co-sintering process using a sintering aid, and consequently, greatly improving the performance of the unit cell.

In the present disclosure, the electrolyte bilayer may refer to an electrolyte layer including yttria-stabilized zirconia using a sintering aid and a reaction barrier layer including samarium-doped ceria.

Hereinafter, the present disclosure will be described in more detail.

In one example of the present disclosure, preparing at least one fuel electrode support, a fuel electrode functional layer, an electrolyte layer, and a reaction barrier layer, respectively; stacking the fuel electrode support, the fuel electrode functional layer, the electrolyte layer, and the reaction barrier layer to form a laminate; and sintering the laminate; are provided. A method of manufacturing a fuel cell support type solid oxide cell.

In one example, the fuel cell-supporting solid oxide fuel cell includes a half-cell including a stack of a fuel electrode functional layer, an electrolyte layer, and a reaction barrier layer on one surface of at least one fuel electrode support layer, and an oxygen electrode layer formed on the other surface of the reaction barrier layer on which the electrolyte layer is formed.

In the present disclosure, co-sintering refers to a process of simultaneously sintering two or more different materials (e.g., ‘yttria (Y₂O₃) stabilized zirconia (YSZ)’ used as an electrolyte material and ‘Sm (samarium) doped ceria (SDC)’).

The laminate may be formed by stacking a fuel electrode support, a fuel electrode functional layer, an electrolyte layer, and a reaction barrier layer at 60 to 80° C. and a pressure of 4000 to 6000 psi. When stacking at the above-described temperature and pressure, optimal interlayer bonding can be ensured.

When the stacking is completed, an oxygen electrode layer is formed on one surface of the stacked body to manufacture a unit cell. At this time, an LSCF (lanthanum strontium cobaltite ferrite)-GDC (gadolinium-doped ceria) composite layer can be used as the oxygen electrode, and it can be formed using a screen-printing method using a calendared mesh.

The sintering step may include sintering the laminate at 1240° C. or higher and lower than 1280° C. for 2 to 6 hours, specifically at 1250 to 1260° C. for 4 hours, and more specifically at 1250° C. for 4 hours. When sintering is performed at the temperature and for the time, the electrolyte layer may be densely formed, a separation phenomenon from the fuel electrode may be prevented, and cell ohmic resistance may be decreased.

The fuel electrode support and the fuel electrode functional layer may each include a sheet obtained by tape casting a slurry including at least one selected from the group consisting of nickel oxide (NiO), yttria-stabilized zirconia (YSZ), a pore former, and combinations thereof.

The nickel (Ni) is a representative hydrogen oxidation reaction catalyst and is inexpensive, and thus is a representative material used as a fuel electrode. However, when only Ni is used to form the fuel electrode layer, the mechanical strength is very poor. Therefore, it is generally desirable to form a cermet with a ceramic that is the same material as the electrolyte.

In one example, YSZ, GDC, etc. may be applied on the ceramic, and specifically, it may be yttria-stabilized zirconia (YSZ).

The pore-forming agent may include at least one selected from the group consisting of carbon black, graphite, starch, and combinations thereof.

In one example, the fuel electrode support may include 40 to 60 wt % of nickel oxide, 5 to 25 wt % of a pore former, and a remainder of yttria-stabilized zirconia to manufacture a slurry. When the nickel oxide is included in the above-described range, the performance of the fuel cell may be excellent, and when the pore former is included in the above-described range, the flatness and pore structure of the fuel cell may be excellent.

In one example, the fuel electrode functional layer may include 40 to 60 wt % of nickel oxide, 0 to 20 wt % of a pore former, and a remainder of yttria-stabilized zirconia to manufacture a slurry. When the nickel oxide is included in the above-described range, the performance of the fuel cell may be excellent, and when the pore former is included in the above-described range, the flatness and pore structure of the fuel cell may be excellent.

The electrolyte layer may include a sheet obtained by tape-casting a slurry containing yttria-stabilized zirconia (YSZ).

The electrolyte included in the electrolyte layer is a substance that serves as a medium for transferring ions in an electrochemical device. In a solid oxide cell, it mainly conducts oxygen ions to enable the operation of a fuel cell or an electrolytic cell.

The electrolyte layer may further include a sintering aid in the slurry.

The sintering aid may include one or more selected from the group consisting of copper, copper oxide, cobalt, cobalt oxide, manganese, manganese oxide, zinc, zinc oxide, iron, iron oxide, lithium, and lithium oxide.

In one example, the electrolyte layer may include a sintering aid of 1 to 3 wt % of yttria-stabilized zirconia. When the sintering aid is included in the above range, a dense electrolyte layer can be manufactured, and yttria-stabilized zirconia can be prevented from being peeled off from the fuel electrode.

The reaction barrier layer may include a sheet obtained by tape-casting a slurry containing samaria-doped ceria (SDC).

The reaction barrier layer may include samaria-doped ceria represented by the following Chemical Formula 1.

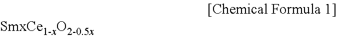

Herein, x is between 0.1 and 0.3.

When the samaria-doped ceria represented by Formula 1 (that is, when x is in the range of 0.1 to 0.3) is included, optimal reaction barrier layer ionic conductivity and sinterability can be ensured.

The reaction barrier layer may further include a sintering aid in the slurry. The sintering aid is the same as the sintering aid that may be included in the electrolyte layer.

In one example, the reaction barrier layer may include a sintering aid of 0 to 3 wt % based on a total of 100 wt % of samaria-doped ceria. The electrolyte layer including the sintering aid in the above range and the reaction barrier layer may prevent pores from being formed therebetween, and thus, there is an effect of excellent fuel cell performance and durability.

The reaction barrier layer is provided to prevent a reaction between a material constituting the electrolyte layer and a material constituting the oxygen electrode layer described later. For example, when the electrolyte layer includes a zirconia-based oxide and the oxygen electrode layer includes LSC or LSCF, the LSC or LSCF constituting the oxygen electrode layer reacts with the zirconia-based oxide constituting the electrolyte layer to form a complex oxide having low ionic conductivity and electrical conductivity at the interface between the electrolyte layer and the oxygen electrode layer during the sintering process of the oxygen electrode layer or while the cell operates at high temperature. By including the reaction barrier layer on one surface of the electrolyte layer as described above, this can be prevented.

The method may further include forming an oxygen electrode (cathode) layer on one surface of the reaction barrier layer. The oxygen electrode (cathode) layer may be formed of two or more layers, and preferably two or three layers.

In one example of the present disclosure, there is provided a fuel electrode-supported solid oxide fuel cell manufactured according to the method of manufacturing a fuel electrode-supported solid oxide fuel cell described above.

The fuel electrode-supported solid oxide fuel cell may include a fuel electrode support; a fuel electrode functional layer; an electrolyte layer; and a reaction barrier layer.

The fuel electrode support; the fuel electrode functional layer; the electrolyte layer; and the reaction barrier layer; will not be described again as they overlap with the contents described in the method of manufacturing the fuel electrode-supported solid oxide fuel cell described above.

The fuel electrode-supported solid oxide cell may be applied to a fuel cell or an electrolysis system.

The above description has been made using one example of the technical idea of the present disclosure, and a person having ordinary knowledge in the technical field to which the present disclosure pertains can make various modifications and changes within a range not departing from the essential characteristics of the present disclosure. Therefore, the examples described in the present disclosure are for explaining, not for limiting, the technical idea of the present disclosure, and the scope of the technical idea of the present disclosure is not limited by these examples. The protection scope of the present disclosure should be interpreted by the claims, and all technical ideas within an equivalent range should be interpreted as being included in the right scope of the present disclosure.

### EXAMPLE

### Preparation Example 1: Preparation of a Fuel Electrode Support

Nickel oxide (NiO), yttria-stabilized zirconia (YSZ), and starch were mixed in a weight ratio of 42.5:42.5:15 to obtain a powder. The powder and a solvent were mixed in a weight ratio of 66:34 and ball-milled for about 24 hours. At this time, the solvent was used in a form mixed in a weight ratio of 45.9:50.3:3.8 of ethanol, xylene, and fish oil to prepare a slurry.

To the slurry 100 parts by weight, 0.02 parts by weight of butyl benzyl phthalate and polyalkylene glycol (Tape-casting warehouse, US) as plasticizers, and 0.03 parts by weight of poly (vinyl butyral) (PVB) as a binder were added. After ball milling for about 24 hours, tape casting was performed to obtain a fuel electrode support sheet.

### Preparation Example 2: Preparation of a Fuel Electrode Functional Layer

Nickel oxide (NiO) and yttria-stabilized zirconia (YSZ) were mixed in a 50:50 weight ratio to obtain powder. The powder and solvent were mixed in a 66:34 weight ratio and ball milled for about 24 hours. At this time, a mixture of ethanol, xylene, and fish oil in a weight ratio of 45.9:50.3:3.8 was used as the solvent to prepare a slurry.

To the slurry 100 parts by weight, 0.02 parts by weight of butyl benzyl phthalate and polyalkylene glycol (Tape-casting warehouse, US) as plasticizers, and 0.03 parts by weight of poly(vinyl butyral) (PVB) as a binder were added. After ball milling for about 24 hours, tape casting was performed to obtain a fuel electrode functional layer sheet.

### Preparation Example 3: Preparation of Electrolyte Layer

Iron oxide (Fe₂O₃) and yttria-stabilized zirconia (YSZ) were mixed in a weight ratio of 1.2:98.8 to obtain a powder. The powder and a solvent were mixed in a weight ratio of 63.9:36.1 and then ball-milled for about 24 hours. Here, a solvent was prepared by mixing ethanol, xylene, and Fish oil in a weight ratio of 46:50.5:3.5 to prepare a slurry.

To the slurry 100 parts by weight, 0.03 parts by weight of butyl benzyl phthalate and polyalkylene glycol (Tape-casting warehouse, US) as plasticizers, and 0.03 parts by weight of poly(vinyl butyral) (PVB) as a binder were added. After ball milling for about 24 hours, tape casting was performed to obtain an electrolyte layer sheet.

### Preparation Example 4: Preparation of the Reaction Barrier Layer

Iron oxide (Fe₂O₃) and samaria-doped ceria (SDC, SmₓCe₁₋ₓO_{2-0.5x}) in a 1:99 weight ratio were mixed to obtain a powder. The SDC composition used was x=0.1. The powder and solvent were mixed in a 63:37 weight ratio and ball milled for about 24 hours. The solvent was a mixture of ethanol, xylene, and Fish oil in a 46:50.5:3.5 weight ratio, and used to prepare a slurry.

To the slurry 100 parts by weight, 0.02 parts by weight of butyl benzyl phthalate and polyalkylene glycol (Tape-casting warehouse, US) as plasticizers, and 0.02 parts by weight of poly(vinyl butyral) (PVB) as a binder were added. After ball milling for about 24 hours, tape casting was performed to obtain an reaction barrier layer sheet.

### EXAMPLE

### Example 1

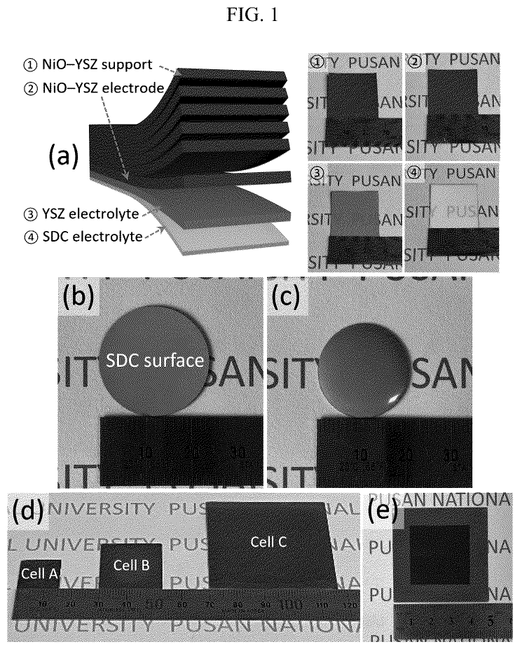

The NiO-YSZ (Y₂O₃-stabilized ZrO₂) support, NiO-YSZ fuel electrode functional layer, YSZ electrolyte layer, and SDC (Sm-doped CeO₂) reaction barrier layer sheets formed using tape casting as in Production Examples 1 to 4 were laminated by uniaxial pressing at 70° C. and 5000 psi using a laminating device, and co-fired at 1250° C. for 4 hours using an electric furnace to manufacture a half-cell. Thereafter, an oxygen electrode layer was separately laminated on the reaction barrier layer through a conventional wet coating process and sintered at 1100° C. to manufacture a unit cell (FIG. 1).

### Example 2

In Preparation Example 1, a unit cell was prepared in the same method and conditions as Example 1 except that nickel oxide (NiO), yttria-stabilized zirconia (YSZ), and starch (Starch) 42.5:42.5:15 was replaced with 45:45:10.

### Example 3

In Example 3, a unit cell was prepared in the same manner and under the same conditions as in Example 1, except that YSZ and Fe₂O₃ 98.8:1.2 were replaced with 97.6:2.4.

### Example 4

In Example 4, a unit cell was prepared in the same manner and under the same conditions as in Example 1, except that 0.2 was used instead of 0.1 for the SDC composition x.

### COMPARATIVE EXAMPLE

### Comparative Example 1

In Preparation Example 1, a unit cell was prepared in the same manner and under the same conditions as in Example 1, except that 35:35:30 of nickel oxide (NiO), yttria-stabilized zirconia (YSZ), and starch were used instead of 42.5:42.5:15.

### Comparative Example 2

In Preparation Example 1, a unit cell was prepared under the same method and conditions as in Example 1, except that 32.5:52.5:15 of nickel oxide (NiO), yttria-stabilized zirconia (YSZ), and starch (Starch) was used instead of 42.5:42.5:15.

### Comparative Example 3

In Preparation Example 2, a unit cell was prepared in the same method and conditions as Example 1, except that nickel oxide (NiO), yttria-stabilized zirconia (YSZ), and graphite 35:35:30 were used instead of nickel oxide (NiO) and yttria-stabilized zirconia (YSZ) 50:50.

### Comparative Example 4

In Preparation Example 2, a unit cell was prepared in the same manner and under the same conditions as in Example 1, except that 30:70 of nickel oxide (NiO) and yttria-stabilized zirconia (YSZ) was used instead of 50:50.

### Comparative Example 5

In Example 3, a unit cell was prepared in the same manner and under the same conditions as in Example 1, except that only yttria-stabilized zirconia (YSZ) was used instead of yttria-stabilized zirconia (YSZ) and Fe₂O₃ 98.8:1.2.

### Comparative Example 6

In Example 3, a unit cell was prepared under the same method and conditions as in Example 1, except that 94.5:5.5 of YSZ and Fe₂O₃ were used instead of 98.8:1.2.

### Comparative Example 7

In Preparation Example 4, a unit cell was prepared under the same method and conditions as Example 1, except that the used SDC composition used x=0.05 instead of x=0.1.

### Comparative Example 8

In Example 4, a unit cell was prepared in the same manner and under the same conditions as in Example 1, except that SDC and Fe₂O₃ 99:1 was replaced with 94:6.

### Comparative Example 9

In Example 1, a unit cell was manufactured under the same method and conditions as in Example 1, except that the laminate was sintered at 1230° C. instead of 1250° C.

### Comparative Example 10

In Example 1, a unit cell was manufactured under the same method and conditions as in Example 1, except that the laminate was sintered at 1280° C. instead of 1250° C.

### Comparative Example 11

In Preparation Example 1, a unit cell was prepared in the same manner and under the same conditions as in Example 1, except that 48:48:4 was used instead of nickel oxide (NiO), yttria-stabilized zirconia (YSZ), and starch 42.5:42.5:15.

### Comparative Example 12

In Preparation Example 1, a unit cell was prepared under the same method and conditions as in Example 1, except that 65:20:15 of nickel oxide (NiO), yttria-stabilized zirconia (YSZ), and starch were used instead of 42.5:42.5:15.

### Comparative Example 13

In Preparation Example 2, a unit cell was prepared in the same manner and under the same conditions as in Example 1, except that 65:35 of nickel oxide (NiO) and yttria-stabilized zirconia (YSZ) was used instead of 50:50.

### Comparative Example 14

In Preparation Example 4, the unit cell was prepared under the same method and conditions as in Example 1, except that the used SDC composition used x=0.4 instead of x=0.1.

### Experimental Example

### Experimental Example 1: Confirmation of Microstructure of Solid Oxide Unit Cell

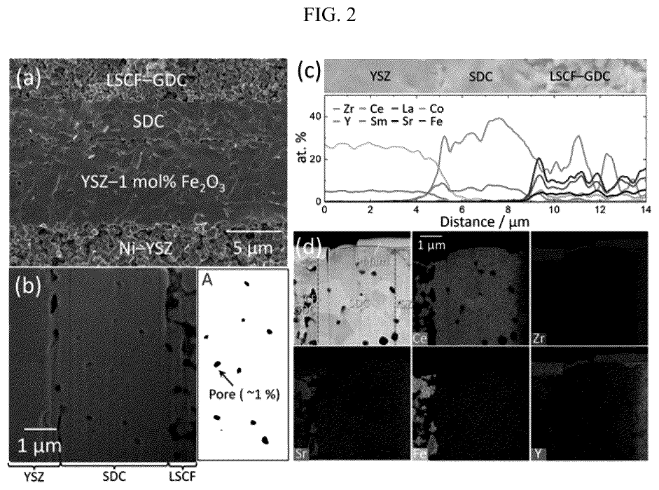

To analyze the microstructure of the solid oxide unit cell manufactured according to Example 1, the fracture surface SEM, FIB-SEM, SEM-EDS were taken/measured under an applied voltage condition of 5 kV, and TEM-EDS was taken/measured under an applied voltage condition of 200 kV, and the results are shown in FIG. 2.

FIG. 2 (a) shows a fracture surface SEM image, (b) shows an FIB-SEM image, (c) shows an SEM-EDS analysis result, and (d) shows a TEM-EDS analysis result.

In FIG. 2(a), a non-peeling organic bonding state of each layer can be confirmed, and it can be confirmed that the electrolyte layer is formed very densely. It was confirmed through FIG. 2(b) that the SDC layer has pores of about 1%. FIGS. 2(c) and (d) prove that there is no undesirable interdiffusion between the layers.

To analyze the microstructure of the solid oxide unit cell fabricated according to Example 3, a fractured surface SEM was taken under an applied voltage condition of 5 kV, and the result is shown in FIG. 10.

FIG. 10 shows that a double-layer electrolyte is densely formed.

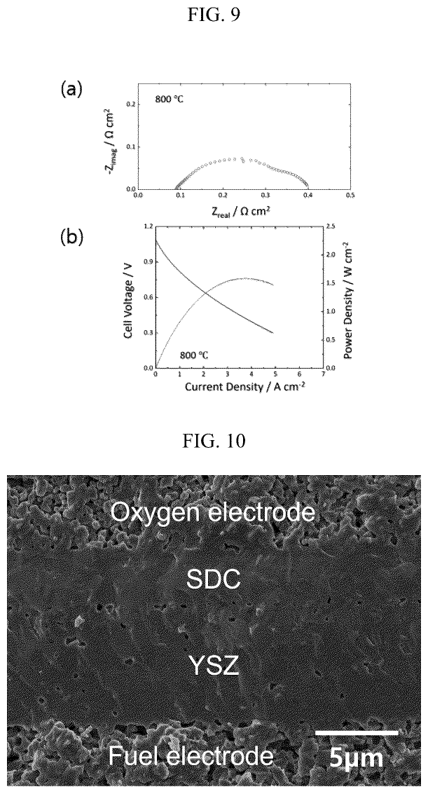

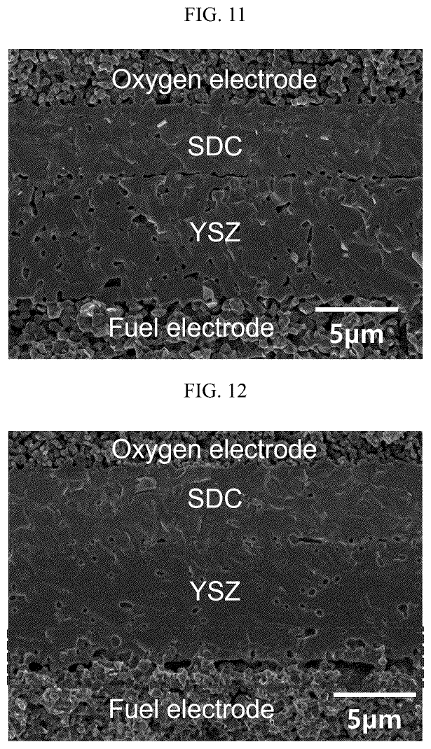

To analyze the microstructure of the solid oxide unit cell manufactured according to Comparative Example 5, a fractured surface SEM was taken under a condition of an applied voltage of 5 kV, and the result is shown in FIG. 11.

Referring to FIG. 11, if the sintering aid is not included, YSZ of the electrolyte layer is formed to be porous, and thus it can be confirmed that the fuel cell does not work.

To analyze the microstructure of the solid oxide unit cell fabricated according to Comparative Example 6, a fractured surface SEM was taken under a condition of an applied voltage of 5 kV, and the result is shown in FIG. 12.

Referring to FIG. 12, when the content of the sintering aid exceeds the above-described range, it was confirmed that the YSZ electrolyte layer is peeled off from the fuel electrode functional layer.

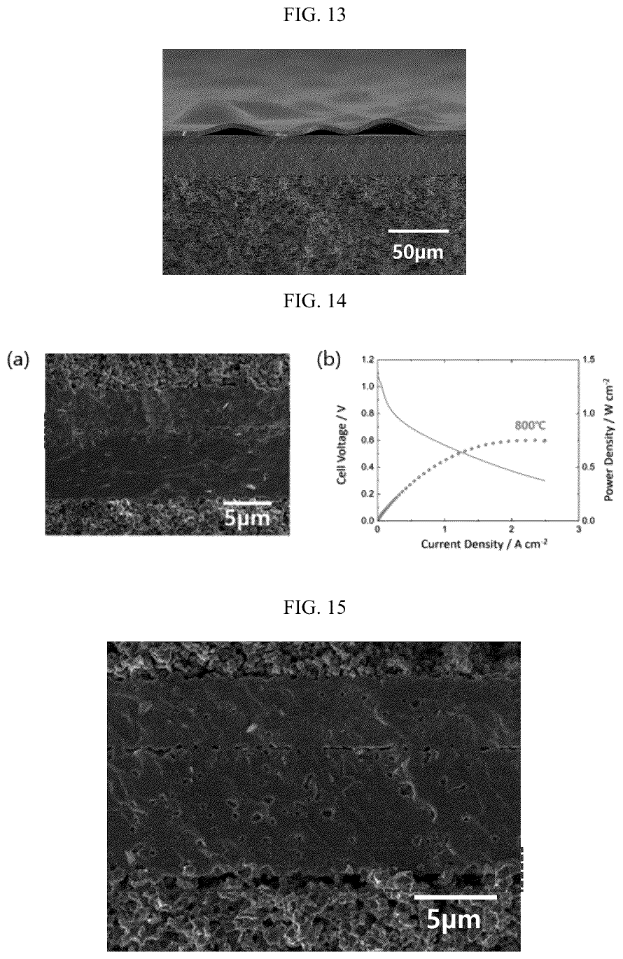

To analyze the microstructure of the solid oxide unit cell manufactured according to Comparative Example 7, a fractured surface SEM was taken under a condition of an applied voltage of 5 kV, and the result is shown in FIG. 13.

Referring to FIG. 13, when the content of samaria does not fall within the above-described range, it was confirmed that the reaction barrier layer was peeled off from the electrolyte layer.

In order to analyze the microstructure of the solid oxide unit cell manufactured according to Comparative Example 8, a fractured surface SEM was taken under a condition of applying a voltage of 5 kV, and the cell performance was measured under a condition of supplying 100 sccm of 3% humidified hydrogen and 300 sccm of air, and the result is shown in FIG. 14.

FIG. 14 (a) is a SEM image of a fractured surface, and (b) is a fuel cell performance result.

Referring to FIG. 14, when the content of the sintering aid exceeds the above-described range, pores are formed between the electrolyte layer and the reaction barrier layer, and it was confirmed that fuel cell performance was reduced.

To analyze the microstructure of the solid oxide unit cell fabricated according to Comparative Example 9, a fractured surface SEM was taken under a condition of an applied voltage of 5 kV, and the result is shown in FIG. 15.

Referring to FIG. 15, it was confirmed that when the firing temperature is less than 1240° C., the electrolyte layer is not dense and peeling occurs from the fuel electrode functional layer.

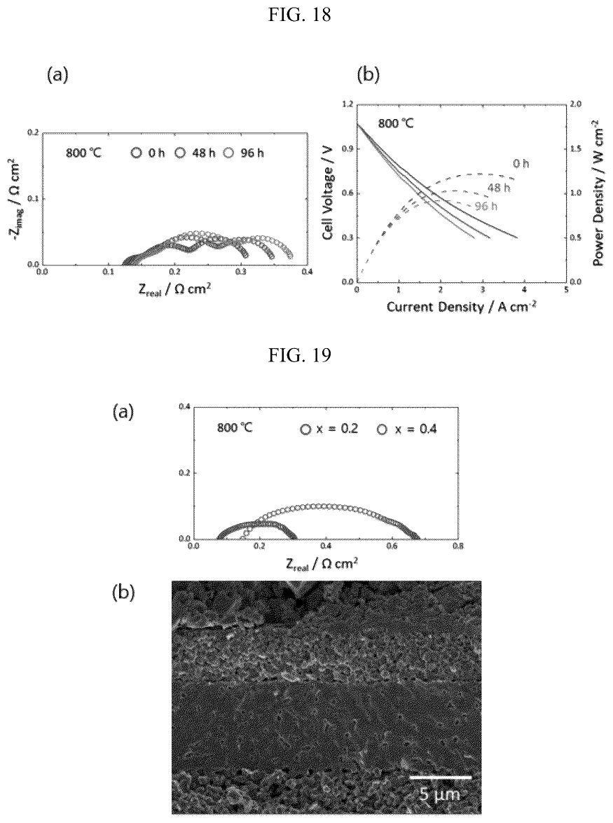

To analyze the microstructure of the solid oxide unit cell manufactured according to Comparative Example 14, a fractured surface SEM was taken under a condition of an applied voltage of 5 kV, and the result is shown in FIG. 19(b).

Referring to FIG. 19(b), when the samarium content does not include the above-described range, the sinterability of the ceria layer is deteriorated and not dense, and the performance of the resulting fuel cell decreases (increase in ohmic and polarization resistance).

### Experimental Example 2: Confirmation of Fuel Cell and Steam Electrolysis Performance of Solid Oxide Unit Cell

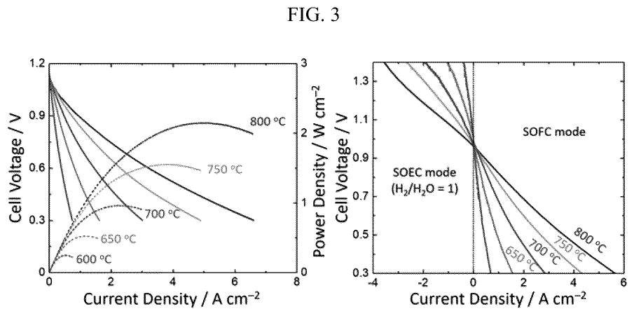

The solid oxide unit cell manufactured according to Example 1 was measured using Bio-Logic SP 240 equipment under the condition of supplying 100 sccm of humidified hydrogen and 300 sccm of air, and the result is shown in FIG. 3. When the humidification degree is 3%, a fuel cell is formed, and when it is 50%, an electrolysis operating environment is created.

The left image of FIG. 3 is a current-voltage-power curve in a fuel cell, and the right image is a current-voltage curve in steam electrolysis.

The open circuit voltage (OCV) of the fuel cell changes from about 1.11 V at 800° C. to about 1.14 V at 600° C., and from 0.96 V to about 1.00 V under electrolysis conditions, presenting a good approximation of the theoretical Nernst potential. This indicates that there is no gas leakage through the dual-layer electrolyte. The peak power density of the fuel cell reaches about 2.15 W cm⁻² at 800° C. and about 0.52 W cm⁻² at 650° C., and a steam electrolysis current density of about 2.95 A cm⁻² and 0.71 A cm⁻² at 800° C. and 650° C., respectively, is achieved at an electrolysis voltage of 1.3 V.

### Experimental Example 3: Long-Term Stability Test of Solid Oxide Unit Cell in Fuel Cell Mode

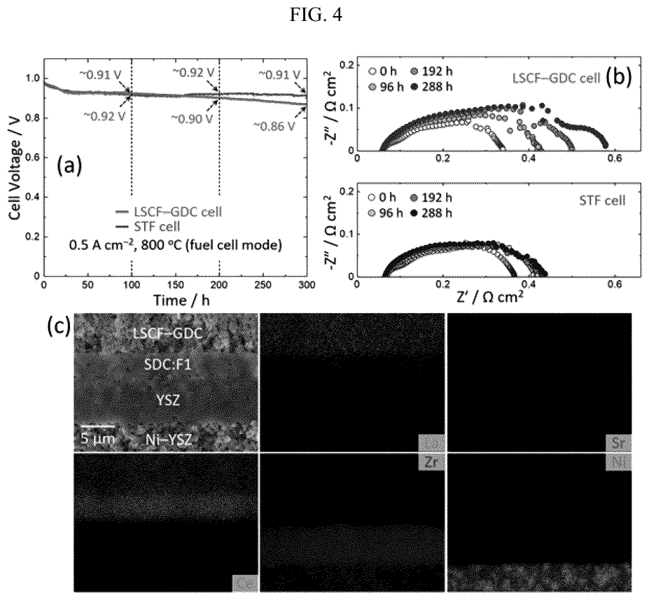

The solid oxide unit cell manufactured according to Example 1 was supplied with 100 sccm of 3% humidified hydrogen and 300 sccm of air, and was measured using Bio-Logic SP 240 equipment under a constant current application condition of 800° C. and 0.5 A cm⁻², and the results are shown in FIG. 4.

FIG. 4(a) shows the change in cell voltage over time, (b) shows the cell impedance over time, and (c) shows the post-microstructure analysis results.

FIG. 4(a) compares the stability of an LSCF-GDC oxygen electrode cell and an Sr(Ti,Fe)O₃ (STF) oxygen electrode cell fabricated by screen printing based on the half-cell developed in this study. During the initial ˜30 hours, the operating voltage of both cells commonly decreased, after which the STF cell was maintained at ˜0.91 V, but the LSCF-GDC cell showed a continuous voltage drop. Referring to FIG. 4(b), this fundamental reason is a problem with the oxygen electrode, and the ohmic resistance, which implies the performance of the bilayer electrolyte, showed no change with time in both cells. FIG. 4(c) suggests that in addition to the structural and chemical stability of the bilayer electrolyte, the inter-electrode interdiffusion is also effectively suppressed.

### Experimental Example 4: Confirmation of Shape and Performance of Solid Oxide Unit Cell

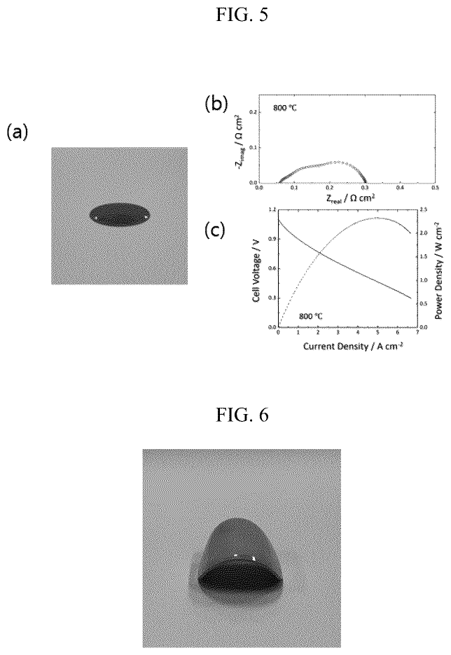

The solid oxide unit cell manufactured according to Example 2 was measured using Bio-Logic SP 240 equipment under conditions of supplying 100 sccm of 3% humidified hydrogen and 300 sccm of air, and the results are shown in FIG. 5.

FIG. 5 (a) is an image of a solid oxide unit cell taken with a camera, (b) shows the impedance results, and (c) shows the voltage-current-power curve results.

FIGS. 5(b) and 5(c) illustrate that there is no change in performance of the fuel cell. Referring to FIG. 5(b), the ohmic and electrode polarization resistances are similar to the initial performance of FIG. 4(b), and referring to FIG. 5(c), the cell voltage and power density are similar to those of FIG. 3.

The solid oxide unit cell manufactured according to Comparative Example 1 was measured using Bio-Logic SP 240 equipment under conditions of supplying 100 sccm of 3% humidified hydrogen and 300 sccm of air, and the results are shown in FIG. 6.

Referring to FIG. 6, when the pore-forming agent is added in an amount of more than 10 to 25 wt %, it was confirmed that the flatness of the fuel cell is not good.

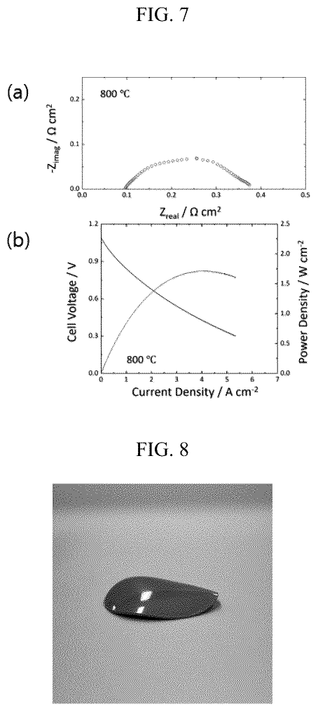

The solid oxide unit cell prepared according to Comparative Example 2 was measured using a Bio-Logic SP 240 device under the condition of supplying 100 sccm of 3% humidified hydrogen and 300 sccm of air, and the result is shown in FIG. 7.

FIG. 7 (a) shows an impedance result and (b) shows a voltage-current-power curve result.

FIG. 7 shows that when the nickel oxide is added out of the range of 40 to 60 wt %, the performance of the fuel cell is degraded (an increase in ohmic resistance).

The solid oxide unit cell fabricated according to Comparative Example 3 was measured using a Bio-Logic SP 240 device under the condition of supplying 100 sccm of 3% humidified hydrogen and 300 sccm of air, and the result is shown in FIG. 8.

FIG. 8 shows that when the pore-forming agent is added out of the range of 10 to 25 wt %, it was confirmed that the flatness of the fuel cell is not good.

The solid oxide unit cell fabricated according to Comparative Example 4 was measured using Bio-Logic SP 240 equipment under the condition of supplying 100 sccm of 3% humidified hydrogen and 300 sccm of air, and the result is shown in FIG. 9.

FIG. 9 (a) shows the impedance results and (b) shows the voltage-current-power curve results.

Referring to FIG. 9, when the nickel oxide is added out of the range of 40 to 60 wt %, it was confirmed that the performance of the fuel cell is deteriorated (increase in ohmic and polarization resistance).

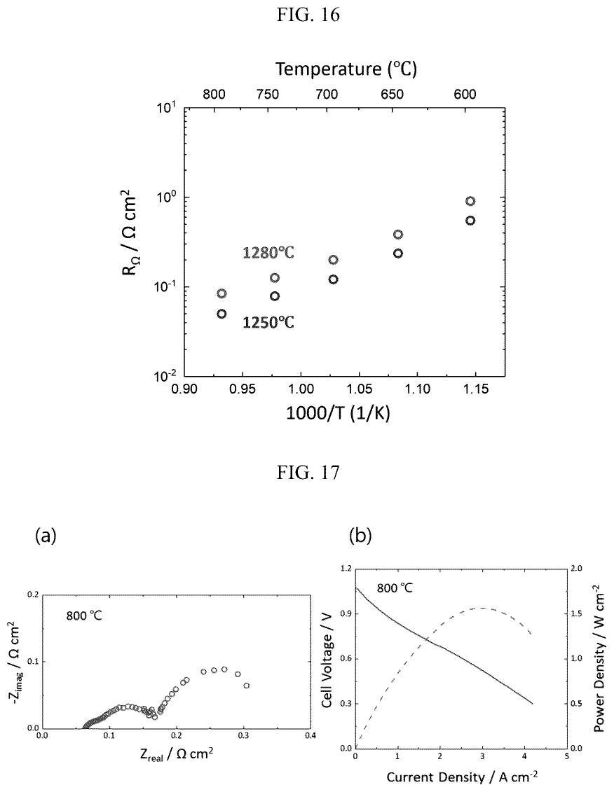

The solid oxide unit cell fabricated according to Comparative Example 10 was measured using Bio-Logic SP 240 equipment under the condition of supplying 100 sccm of 3% humidified hydrogen and 300 sccm of air, and the result is shown in FIG. 16.

FIG. 16 shows the results of comparing the ohmic resistance of cells sintered at 1280° C. and 1250° C.

Referring to FIG. 16, it was found that when the firing temperature is higher than 1280° C., an undesirable diffusion phenomenon between the electrolyte layer and the reaction barrier layer is accelerated, thereby increasing fuel cell ohmic resistance.

The solid oxide unit cell manufactured according to Comparative Example 11 was measured using Bio-Logic SP 240 equipment under the condition of supplying 100 sccm of 3% humidified hydrogen and 300 sccm of air, and the result is shown in FIG. 17.

FIG. 17 (a) shows an impedance result and (b) shows a voltage-current-power curve result.

Referring to FIG. 17, when the pore former is included in an amount of less than 5 wt % in the fuel electrode support, it was confirmed that the fuel is not properly supplied, and as a result, the polarization resistance increases and the performance of the cell deteriorates.

In the solid oxide unit cell manufactured according to Comparative Example 12, it was confirmed that the fuel electrode support included more than 60 wt % of nickel oxide, thereby reducing the mechanical strength of the cell (not shown).

The solid oxide unit cell manufactured according to Comparative Example 13 was measured using Bio-Logic SP 240 equipment under the condition of supplying 100 sccm of 3% humidified hydrogen and 300 sccm of air, and the result is shown in FIG. 18.

FIG. 18 (a) shows an impedance result and (b) shows a voltage-current-power curve result.

Referring to FIG. 18, when the fuel electrode functional layer includes more than 60 wt % of nickel oxide, it was confirmed that the polarization of the cell continuously increases over time, resulting in decreased stability.

The solid oxide unit cells prepared according to Example 4 and Comparative Example 14 were measured using Bio-Logic SP 240 equipment under the condition of supplying 100 sccm of 3% humidified hydrogen and 300 sccm of air, and the results are shown in FIG. 19(a).

Referring to FIG. 19(a), it can be seen that when x exceeds 0.3, the conductivity of the SDC decreases, and thus, the fuel cell ohmic resistance increases.

Although the present disclosure has been described with reference to the examples, the present disclosure is not limited to the examples disclosed in the present specification, and various modifications can be made by those skilled in the art within the scope of the technical spirit of the present disclosure. It is obvious that. In addition, although the operational effects according to the configuration of the present disclosure have not been explicitly described while describing the examples of the present disclosure, it is natural that the effects predictable from the configuration should be recognized.

What is claimed is:

1. A method for manufacturing a fuel electrode supported solid oxide cell comprising:
preparing at least one of fuel electrode supports, a fuel electrode functional layer, an electrolyte layer, and a reaction barrier layer, respectively;
stacking the fuel electrode support, the fuel electrode functional layer, the electrolyte layer, and the reaction barrier layer to form a laminate; and
co-firing the laminate at 1240° C. or higher and lower than 1280° C. for 2 to 6 hours.

2. The method of claim 1,
the laminate is formed by laminating the fuel electrode support, the fuel electrode functional layer, the electrolyte layer, and the reaction barrier layer at 60 to 80° C. and a pressure of 4000 to 6000 psi.

3. The method of claim 1,
wherein the laminate is formed by sequentially stacking the fuel electrode functional layer, the electrolyte layer, and the reaction barrier layer on one surface of the at least one of fuel electrode supports.

4. The method of claim 1,
wherein the co-firing further comprises, co-firing the laminate at 1250 to 1260° C. for 4 hours.

5. The method of claim 1,
wherein the fuel electrode support and the fuel electrode functional layer each comprises a sheet obtained by tape-casting a slurry comprising at least one selected from the group consisting of nickel oxide (NiO), yttria-stabilized zirconia (YSZ), a pore former, and combinations thereof.

6. The method of claim 1,
wherein the electrolyte layer comprises a sheet obtained by tape-casting a slurry comprising yttria-stabilized zirconia (YSZ).

7. The method of claim 1,
wherein the reaction barrier layer comprises a sheet obtained by tape-casting a slurry comprising samarium-doped ceria (SDC).

8. The method of claim 6,
wherein the electrolyte layer or the reaction barrier layer further comprises a sintering aid in the slurry.

9. The method of claim 8,
wherein the sintering aid comprises at least one selected from the group consisting of copper, copper oxide, cobalt, cobalt oxide, manganese, manganese oxide, zinc, zinc oxide, iron, iron oxide, lithium, and lithium oxide.

10. The method of claim 8,
wherein the electrolyte layer comprises 1 to 3 wt % of a sintering aid based on 100 wt % of yttria-stabilized zirconia.

11. The method of claim 8,
wherein the reaction barrier layer comprises 0 to 3 wt % of sintering aid of samaria-doped ceria based on 100 wt % of total.

12. The method of claim 7,
wherein the reaction barrier layer comprises samaria-doped ceria represented by the following Chemical Formula 1:
SmxCe_{1.x}O_{2-0.5x} [Chemical Formula 1]
Herein, x is between 0.1 and 0.3.

13. The method of claim 5,
wherein the pore-forming agent comprises at least one selected from the group consisting of carbon black, graphite, starch, and combinations thereof.

14. The method of claim 5,
wherein the fuel electrode support comprises 40 to 60 wt % of nickel oxide, 5 to 25 wt % of a pore former, and a remainder of yttria-stabilized zirconia to prepare a slurry.

15. The method of claim 5,
wherein the fuel electrode functional layer comprises 40 to 60 wt % of nickel oxide, 0 to 20 wt % of a pore former, and the remainder of yttria-stabilized zirconia to prepare a slurry.

16. The method of claim 1, further comprising:
forming an oxygen electrode (cathode) layer on one surface of the reaction barrier layer.

17. A fuel electrode supported solid oxide cell manufactured by the manufacturing method according to claim 1.

18. The fuel electrode supported solid oxide cell of claim 17,
wherein the fuel electrode supported solid oxide cell is applicable to a fuel cell or an electrolysis system.

19. The method of claim 7,
wherein the electrolyte layer or the reaction prevention layer further comprises a sintering aid in the slurry.
